(19) United States
(12) Patent Application Publication
(10) Pub. No.: US 2022/0108311 A1
(43) Pub. Date: Apr. 7, 2022

(54) APPLICATION FOR CREATING REAL TIME SMART CONTRACTS

(71) Applicant: INVESTA TECH CONSULTING, INC., Nevis (KN)

(72) Inventors: Jose Ali Vivas, Conroe, TX (US); Gustavo Muci, Montevideo (UY); Diego Primavesi, Montevideo (UY)

(21) Appl. No.: 17/504,170

(22) Filed: Oct. 18, 2021

Related U.S. Application Data
(63) Continuation of application No. 16/426,177, filed on May 30, 2019, now abandoned.
(60) Provisional application No. 62/677,973, filed on May 30, 2018.

(51) Int. Cl. G06Q 20/38; G06Q 20/40; G06F 3/0482; H04L 9/06; G06Q 20/06

(52) U.S. Cl. CPC G06Q 20/3829; G06Q 20/40; G06F 3/0482; H04L 2209/38; G06Q 20/0658; H04L 2209/56; H04L 9/0643

(57) ABSTRACT

Systems and methods are provided for creating and modifying smart contracts. A method for creating a smart contract can include receiving one or more commands that include a parameter for the smart contract and generating, based on the one or more commands, an entry that is part of an agreement structure. The method can also include receiving input from different devices that approve the entry in the agreement structure as well as generating one or more milestones associated with the smart contract. The milestones can be converted and saved using a distributed ledger technology such as blockchain.

### TECHNICAL FIELD

The present technology pertains to the field of Blockchain technology, and more particularly, a software application for real-time creation of smart contracts.

### BACKGROUND

The process for parties to enter into a ‘traditional’ contract typically involves a series of negotiations between the parties and/or their attorneys to develop the general terms of the agreement. The parties usually memorialize the agreement in the form of a written contract that is drafted and edited by the parties and their attorneys. The process of drafting the contract is inherently delayed due to the numerous revisions that are typically required and the asynchronous nature of the back and forth communications between all of the individuals involved. Moreover, valuable information relating to the negotiations involved with reaching an agreement is often lost because it is not included in the final written document.

A party seeking to enforce a traditional contract or collect damages for breach of a traditional contract can likewise face challenges that are both time-consuming and expensive. The aggrieved party will typically need to retain an attorney in order to collect evidence of non-compliance or breach through discovery processes via the judicial system. Obtaining evidence from an adverse party in litigation is onerous and expensive. In addition, it may be necessary to retain experts to perform review and interpret the evidence, such as a computer expert to perform digital forensics on electronic devices and electronic data.

A ‘smart contract’ refers to a computer protocol that facilitates verification and enforcement of an agreement. While a smart contract provides a means to digitally create and document a traditional contract, creating a smart contract requires parties to engage a computer programmer having specialized knowledge of the sophisticated software used to create smart contracts. Thus, similar to traditional contracts, the parties are dependent upon others to create a smart contract and the process can be expensive, inherently time consuming, and unnecessarily delayed. Consequently, there is a need for a software application that uses simple commands to facilitate the expeditious creation of a smart contract directly between contracting parties and also enables, monitors, and records the negotiation process.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system configuration;

FIG. 2 illustrates an exemplary graphical user interface;

FIG. 3 illustrates an exemplary method embodiment;

FIG. 4 illustrates an exemplary method embodiment;

FIG. 5 illustrates an exemplary method embodiment; and

FIG. 6A and FIG. 6B illustrate exemplary system embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the scope of the disclosure.

The disclosed technology addresses the need in the art for an efficient manner to create a smart contract. The present technology will enable users to quickly and efficiently create a smart contract, and all milestones relating to the formation and performance of the smart contract can be documented, stored, retrieved, and inspected. In particular, the present technology is directed to systems, methods, devices, and non-transitory computer-readable storage media for creating smart contracts.

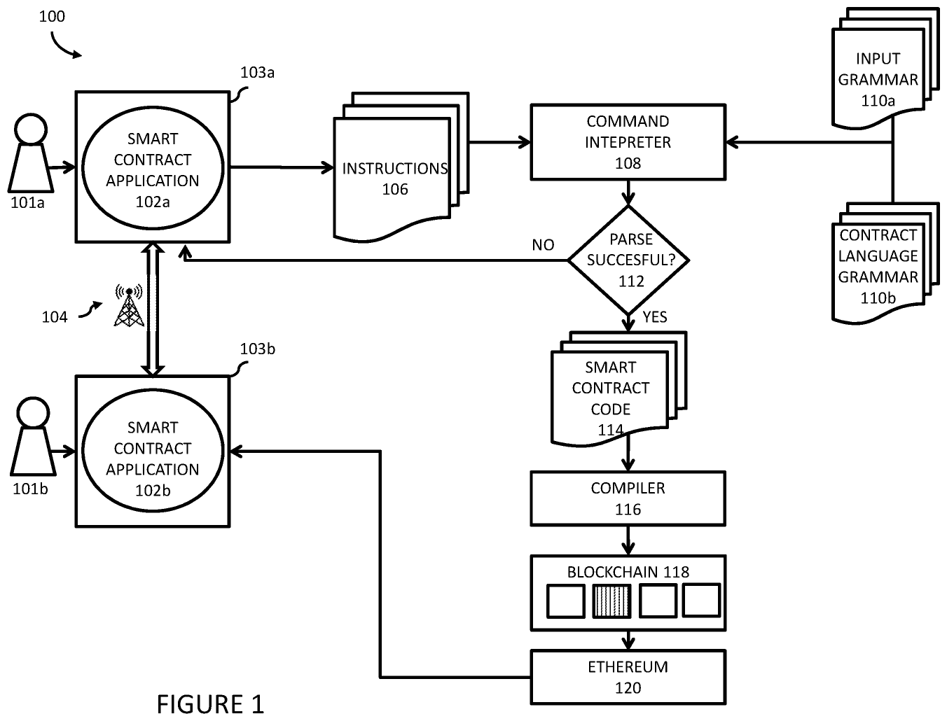

An exemplary system configuration for the present technology is illustrated in FIG. 1, wherein users 101a and 101b can utilize devices 103a and 103b to execute smart contract applications 102a and 102b, respectively. Devices 103a and 103b can communicate via a communications interface 104 for the purposes of exchanging content or other data. Communications interface 104 can be a network such as a wide area network, a local area network, a cellular network, a virtual private network, a peer-to-peer network, etc. or it can be a direct connection such as Bluetooth, Near Field Communications (NFC), Infrared, Wi-Fi direct, LTE-direct, etc. or any other type of network or proximity-based protocol configured to facilitate inter-device communication.

Smart contract application 102 can also be configured to facilitate communication between users 101a and 101b via text, instant messaging, email, voice call, or video call. This communication can be used for the purpose of exchanging information or negotiating terms for a smart contract. Smart contract application 102 can be configured to monitor, capture, and store the communication among the parties for inclusion in the smart contract.

Smart contract application 102 can be configured to receive and process commands or instructions 106 for creating a smart contract. Examples of commands/instructions 106 that can be used with smart contract application 102 include: IF, THEN, ELSE, WHILE, UNTIL, SEARCH, SAVE, SEND, AND, OR, WRITE, DO, END, PROOF, PAY, TRUE, FALSE, EQUAL, and NOT. The instructions 106 and the command syntax/protocol associated with smart contract application 102 are discussed more fully below.

Instructions 106 can be sent to or retrieved by a command interpreter 108 for monitoring of smart contract application 102a and for parsing and conversion into a contract oriented programming language such as Solidity, Serpent, LLL, Mutan, or Viper. Command interpreter 108 can be configured to manage the application programming interface (API) conditions of smart contract application 102a to detect interaction with other applications such as chat, telephone, camera, email, etc. Instructions 106 sent to command interpreter 108 can include data from smart contract application such as contract text, chat text, and mail, which may include documents, images, videos, etc. pertaining to a particular contract element or condition.

Command interpreter 108 can also be configured to monitor the instructions received to determine if one or more logical conditions that relate to an aspect of the smart contract have been satisfied. Alternatively, the interpreter 108 can make requests to different APIs to determine if a logical condition has been met. Examples of logical conditions can include any data or command relating to contract formation such as an offer, counter-offer, acceptance, performance, payment, or any related evidence/proof thereof.

In some embodiments, command interpreter 108 can be integrated as part of smart contract application 102. Alternatively, command interpreter 108 can consist of standalone software that interfaces with smart contract application 102. Similarly, command interpreter 108 may be executed on the same device 103a as smart contract application 102a, or it may be executed on a separate device or server that is configured to communicate with device 103a.

Upon determining that a logical condition has been met, command interpreter 108 can initiate the process of storing data on blockchain 118. Alternatively, smart contract application 102a can send a command to instruct command interpreter 108 to store particular data on blockchain 118. To facilitate storage on blockchain 118, command interpreter 108 can be configured to parse instructions 106 in order to convert them into a contract oriented language and generate smart contract code 114.

As recognized by those skilled in the art, blockchain 118 is an example of distributed ledger technology (DLT) in which transactions may be recorded in “blocks” of data chronologically and publicly. Each block in the chain can be cryptographically hashed, with each block's hashed data associated with the previous block to ensure the chain is not tampered with and remains unchanged. The chain of data can be stored on multiple devices in a peer-to-peer network.

In order to parse instructions 106 received from smart contract application 102a, interpreter 108 can use input grammar 110a and contract language grammar 110b. Input grammar 110a can specify the syntax of a high-level programming language used by smart contract application 102a. Similarly, contract language grammar 110b can specify the syntax of the contract oriented programming language (e.g. Solidity) that is to be utilized for the smart contract. Command interpreter 108 uses input grammar 110a and contract language grammar 110b to parse, convert, compile, or otherwise transform instructions 106 to smart contract code 114.

Command interpreter 108 can include or otherwise incorporate additional software tools used to parse, convert, or compile instructions 106. In some embodiments, command interpreter 108 can utilize a LEX/YACC (Lexical Analyzer/Yet Another Compiler-Compiler) tool that is modified to integrate contract oriented language commands and can assist in the conversion of instructions 106 to smart contract code 114. In another embodiment, command interpreter 108 can utilize an ANTLR (Another Tool For Language Recognition) adapted to generate contract code 114 from instructions 106. In another embodiment, command interpreter 108 can utilize a source to source tool for handling software language transformation such as DMS. In yet another embodiment, command interpreter 108 can utilize a declarative language such as Kaitai Struct to facilitate conversion of instructions 106 to smart contract code 114. Those that are skilled in the art will recognize that interpreter 108 can be implemented using one or more tools, and the present technology is not limited in scope to the specific examples set forth herein.

After parsing instructions 106, command interpreter 108 can perform verification to determine if parsing of instructions 106 was successful 112. If the parse was not successful, command interpreter 108 can communicate with smart contract application 102a to adjust or reinitiate the conversion process. If the parse was successful, command interpreter 108 can send smart contract code 114 to compiler 116. In some embodiments, compiler 116 can correspond to a Solidity compiler.

Compiler 116 can generate Ethereum Virtual Machine (EVM) bytecode that can be deployed to the Ethereum blockchain 118 for storage and/or execution. Ethereum 120 is an open-source blockchain-based computing platform that provides smart contract functionality. Ethereum platform 120 can provide smart contract application 102 with access to blockchain 118 to facilitate execution and enforcement of smart contracts.

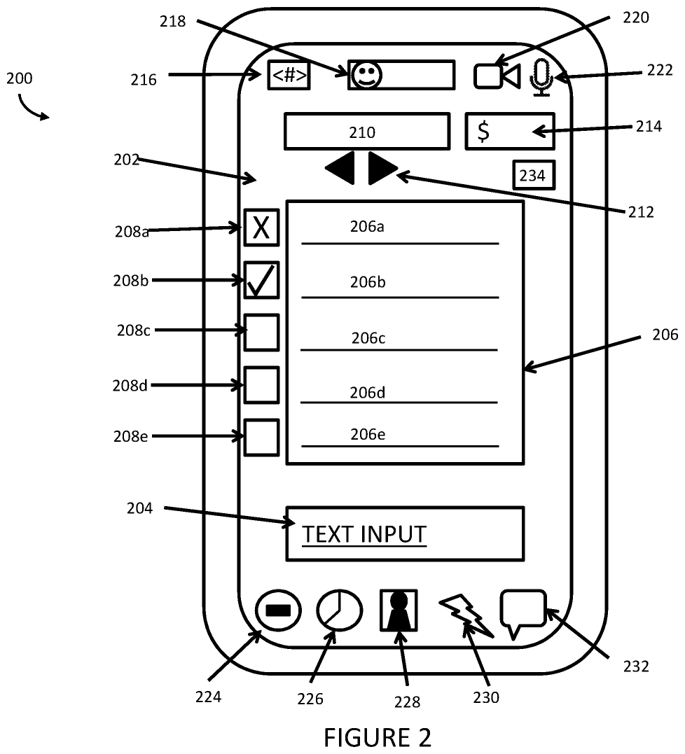

FIG. 2 illustrates an exemplary graphical user interface for the present technology, wherein device 200 corresponds to any type of computing device such as a mobile phone, tablet, laptop, smartwatch, etc. Device 200 can have a screen or display configured to present or render images such as a graphical user interface (GUI) 202.

GUI 202 can include a text input field 204 configured to receive and/or display text corresponding to commands for smart contract application. In one embodiment, a user may directly enter commands in text input field 204 by activating a keyboard function using a mouse, touch screen, or some other input mechanism. Alternatively, a user may enter commands in text input field 204 by using voice commands and utilizing voice to text conversion. In another embodiment, a user may select commands from a drop down list or utilize a help/tutorial function within the smart contract application to assist in composing commands. Text input window 204 can also be used to perform other functions such as composing email, text messages, or instant messages.

GUI 202 can also include an agreement window 206 that can have a plurality of fields such as fields 206a-206e. Agreement window 206 can display one or more commands or text lines in fields 206a-206e. Each of the commands or text lines in agreement window 206 can correspond to portions of an agreement structure entered by the user of device 200 using text input field 204. Alternatively, the command or text lines displayed in agreement window 206 can correspond to portions of an agreement structure received by user from a third party utilizing the smart contract application that may be engaging in an agreement with the user of device 200. A user may select elements displayed within agreement window 206 to make edits.

Each of the fields 206a-206e in agreement window 206 can have a corresponding review window such as review windows 208a-208e. The user of the smart contract application can use review windows 208a-208e to approve or reject one or more elements displayed within agreement window 206. As illustrated, review window 208a includes an ‘X’ which may signify that the user has rejected the command, text, or element displayed in field 206a. Similarly, review window 208b includes a ‘check mark’ icon which may signify that the user has approved or accepted the command, text, or element displayed in field 206b. Review windows 208c-208e are empty which may signify that the user has not yet reviewed the corresponding command, text, or element displayed within agreement window 206. The ‘X’ and ‘check mark’ icons are for illustration purposes only, and those skilled in the art will recognize that other icons, color, or indicia may be used in review windows 208a-208e.

GUI 202 can also include a milestone window 210. Smart contract application can create or identify ‘milestones’ which can correspond to noteworthy events, actions, dates, or conditions related to the agreement. Milestones can be “manually” created or defined by the user, or milestones can be automatically created or suggested by smart contract application based on some predetermined criteria. In some embodiments, a milestone can correspond to a date that performance is due or performed. Examples include the date on which payment is made or expected, the date on which services are rendered or expected to be rendered, the date on which goods are delivered or expected to be delivered.

A milestone can also be created based on an API trigger such as a meeting, telephone conference, chat, email, camera, or any other API “app event” (e.g. smart contract application interacts with another application). For example, if a user takes a photograph of goods received to confirm delivery of goods or to document a deficiency in the goods, smart contract application can create a milestone with this information and store the photograph as proof within the smart contract. In some embodiments, smart contract application may prompt the user for review and approval prior to creating a milestone. Additionally, smart contract application may include menus and options for a user to define or edit the criteria for creating milestones. For example, a user may define a milestone for any payment that is made to or received from a particular contact.

In some embodiments, smart contract application may also monitor a user's interaction with the application to ‘learn’ or suggest milestones. For example, if a user previously defined a milestone pursuant to a telephone conversation with “Mr. Smith,” the application can suggest or automatically define milestones based on subsequent contact with “Mr. Smith.”

Each milestone can be represented in milestone window 210 by a symbol or text. For example, milestone window 210 may display text such as “M1, M2, M3” which can correspond to Milestone #1, Milestone #2, and Milestone #3. A user may utilize milestone window 210 to select a particular milestone and view its associated status. That is, when a user selects a particular milestone, smart contract application can automatically update GUI 202 to display all of the data that is relevant to the selected milestone. By selecting a milestone, a user can review the data in agreement window 206 as well as review windows 208a-208e to determine if any edits or approvals are required.

GUI 202 can also include milestone navigation buttons 212 configured to facilitate selection of different milestones. In one embodiment, milestone navigation buttons 212 can be configured to provide forward/back functionality for browsing milestones in chronological order. In some embodiments, a user can see a preview of each milestone while browsing with milestone navigation buttons 212. As an alternative to milestone navigation buttons 212, a user can enter a SEARCH command in text input field 204 to find a milestone.

GUI 202 can also include an account balance field 214. Account balance field 214 can be configured to display a user's balance in any type of account such as a bank account, investment account, a cryptocurrency wallet, etc. Alternatively, account balance field 214 can be configured to display a balance associated with the particular smart contract that is in the active session of the user's smart contract application. In some embodiments, account balance field 214 can be updated in accordance with the milestone that is presently selected. For example, if user selects a milestone that is in the past, account balance field 214 can reflect the balance at that time.

In some embodiments, smart contract application can be configured to manage multiple smart contracts simultaneously. For example, smart contract application can provide multiple sessions that can be opened simultaneously for the user to toggle. GUI 202 can be configured to include an agreements field 216 that informs the user of the number of open agreements presently available. The agreements field 216 can be used to toggle between different active sessions or to otherwise re-launch a saved agreement.

GUI 202 can also include icons or fields such as party 218, video 220, and audio 222. Party 218 can be configured to display the name and/or picture of the contracting party. In some embodiments, a user may cycle through different open agreements by selecting the name of the contracting party. Alternatively, party 218 can be configured to display the name/picture of the current user. In some embodiments, smart contract application may be configured to work with multiple users by creating separate accounts for each. A user may log out of smart contract application and permit a second user to login to smart contract application using the same device 200.

Video 220 can be used to launch a camera application and utilize its associated video or photo features. For example, video 220 can be used to initiate a video conference between two or more parties to the agreement. In some embodiments, video 220 can permit recording of a video conference between two or more parties, or to record videos of anything that may be pertinent to the agreement. For example, if a smart contract involves performing services such as painting a house, video 220 can be used to record a video of the house after it is painted as evidence that the services were completed. In some embodiments, a request to record video may be initiated using record icon 224. If a request to record a video conference is received, smart contract application can send the request to any third parties for approval prior to commencing the recording process.

Similarly, audio 222 can be used to initiate an audio conference between two or more parties to the agreement. Audio 222 can also be configured to permit recording of an audio conference between two or more parties, or to record audio files of anything that may be pertinent to the agreement. In some embodiments, a request to record audio may be initiated using record icon 224. If a request to record an audio conference is received, smart contract application can send the request to any third parties for approval prior to commencing the recording process.

GUI 202 can also include a time milestone icon 226 that can be configured to create or define new time milestones. GUI 202 can also include a contacts icon 228 that can be configured to display contacts that are associated with the agreement in the current active session. Alternatively, contacts icon 228 can be configured to open the user's contact list to invite one or more new contacts to enter the agreement. GUI 202 can also include a chat icon 232 that can be used to initiate a chat with one or more third parties associated with the agreement. Alternatively, chat icon 232 can be used to search and display previously recorded chats associated with the agreement. GUI 202 can also include an agreement icon 230. Agreement icon 230 can be used to approve one or more aspects of an agreement. For example, agreement icon 230 can be used to ‘globally’ approve all of the elements/conditions associated with a particular milestone. Alternatively, agreement icon 230 can be used to send one or more aspects of a contract to one or more third parties for their edits or approval.

GUI 202 can also include a documents field 234. In some embodiments, documents field 234 can be configured to display the number of documents associated with the presently active smart contract. Alternatively, documents field 234 can be configured to display the number of documents associated with the presently selected milestone. The user may utilize documents field 234 to retrieve related documents to facilitate reviewing and editing of the documents.

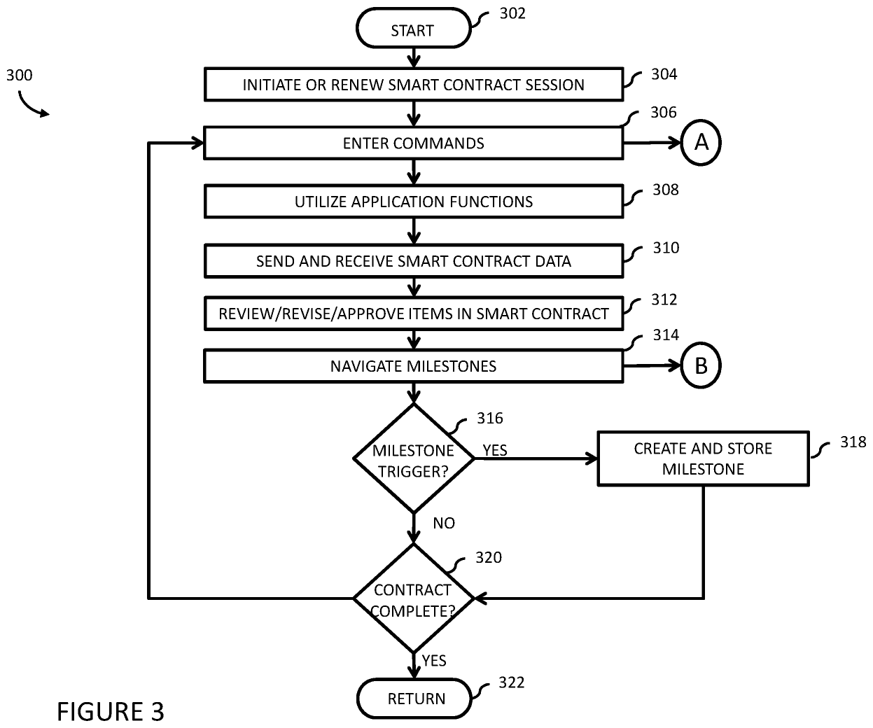

FIG. 3 illustrates an exemplary method 300 in accordance with the present technology. While method 300 is presented as a series of steps, the present technology is not limited in scope to the order presented herein. Those skilled in the art will recognize that the steps in method 300 can be combined, omitted, performed in a different order, or performed in parallel without departing from the scope of the present technology.

Method 300 begins at 302 and proceeds to 304 wherein a user initiates or renews a smart contract session in smart contract application. Initiating a new smart contract session can include assigning a name or identifier to the session and selecting one or more parties that the user wishes to include in a negotiation. Renewing a smart contract session can include opening the smart contract application and selecting an open contract by utilizing the application's graphical user interface such as agreements field 216 discussed above.

Once a smart contract session is active, method 300 can proceed to 306 wherein a user can enter one or more commands or instructions. Examples of commands include but are not limited to: IF, THEN, ELSE, EVENT, WHILE, UNTIL, SEARCH, SAVE, SEND, AND, OR, WRITE, DO, END, PROOF, PAY, TIME, TRUE, FALSE, EQUAL, BID, and NOT.

In some embodiments, each command can be preceded with a command indicator such as a ‘hashtag’ or ‘pound #’ symbol. The hashtag can be typed immediately before the command text to indicate to smart contract application that a command is being entered. Examples of the syntax include ‘#SEND’ or ‘#PROOF’. Those skilled in the art will recognize that a hashtag command indicator is an example and other command indicators are contemplated herein.

In some embodiments, commands can be entered using audio/voice commands. For example, a user may press an icon in GUI 202 such as audio 222 to activate a microphone and then speak the words “hashtag send” in order to enter the ‘#SEND’ command. Likewise, a user may speak the words “hashtag proof” in order to enter the ‘#PROOF’ command.

In some embodiments, smart contract application can be configured to be in a “listen” mode in which the application monitors audio received on a device microphone to detect the “hashtag” command indicator so that user does not need to activate the microphone. That is, a user may simply speak the word “hashtag” to alert smart contract application that an instruction is being entered via voice command. To optimize device battery life, this functionality may be disabled, configured to run only when the smart contract application is active, configured to run only when the device is connected to an external power source such as a charger, or configured to run when the battery is above a certain threshold.

Commands to the smart contract application can include additional nested commands as well as elements entered in natural language. For example, “#IF #EVENT paint house 555 Main Street #THEN #PAY $500.” In this example, the ‘#IF’ command is used to set the initial condition which includes an event that is defined by command ‘#EVENT’ as ‘paint house 555 Main Street.” The command further includes’#THEN′ to define an outcome if the condition is satisfied, which includes a payment ‘#PAY’ of five hundred dollars.

Commands to the smart contract application can also include data such as pictures, videos, audio recordings, documents, etc. For example, “#SEND photo1.jpg” can be used to send a photograph to another party. In another example, “#SEND #PROOF #EVENT paint house video1.avi” can be used to send a video to the other party which serves as proof of performance of painting the house. In some embodiments, smart contract application can prompt the user to select or attach data to commands. Alternatively, smart contract application can provide a mechanism for a user to navigate files, photos, videos, chats, emails, documents, etc. that can be included as part of a command.

Method 300 can proceed to step 308 in which user can utilize functions in smart contract application as described in connection with GUI 202 in FIG. 2. By way of example, these functions can include chat sessions, voice/video conferencing, creating milestones, navigating the milestone toolbar, reviewing/editing items in the agreement, approving/rejecting elements of the agreement, reviewing/editing documents associated with the agreement, reviewing transactions and account balance, entering commands/instructions, etc.

At step 310, smart contract application can be configured to send and receive smart contract data to one or more parties associated with the agreement. For example, after user enters an initial command with the terms of an offer, user may prompt smart contract application to send the offer to one or more third parties. Alternatively, smart contract application may send the offer automatically once it is approved by user. In some instances, the terms of the initial offer may be modified by a third party and sent back to the user as a counteroffer. Alternatively, the third party may return an acknowledgment or approval.

In some embodiments, a user may enter a ‘#BID’ command that is sent to several parties as an invitation to make offers for a particular good or service. The ‘#BID’ command can be configured to automatically accept the best (e.g. highest or lowest) offer received by a set deadline or to accept the first offer that meets a particular set of criteria. Alternatively, user may review bids and select the most favorable for entering into a new agreement.

At step 312, user of smart contract application can review, edit, and/or approve items in the agreement. For example, if user receives a counteroffer modifying one or more performance conditions such as cost, time, quantity, etc., user can view those changes in agreement window 206 of GUI 202. User can then reject or accept the terms by utilizing review windows 208a-208e. Alternatively, user can select a particular element or term in agreement window 206 to revise.

At step 314, user can navigate and review milestones in the agreement. In one example, the user may utilize GUI elements such as navigation buttons 212 to select a particular milestone. Once a milestone is selected, user can review all of the data associated with the milestone. User can also make revisions and approve or reject particular elements of a milestone. In some embodiments, milestones can be classified as event milestones or time milestones. An event milestone can correspond to any asynchronous occurrence relating to the agreement. For example, receipt of a ‘#PROOF’ regarding commencement of a service may be regarded as an event milestone if there was not a set deadline for commencement. Alternatively, a time milestone can correspond to a past or future occurrence that is associated with a particular date. For example, if the contract is conditioned on being completed within 30 days, a time milestone can be stored for the corresponding date as the “final deadline.”

At step 316, smart contract application can detect whether a milestone trigger has occurred. A milestone trigger can include satisfaction of a condition such as receipt of payment, receipt of goods, services completed, etc. A milestone trigger can also include reaching agreement on particular terms and creating corresponding event/time milestones. Milestone triggers can also include application event triggers wherein user utilizes another application in connection with the smart contract (e.g. camera, microphone, chat, email, document editor, etc.).

In some embodiments, the criteria for milestone triggers can be modified or entered by the user. In addition, GUI 202 can include a graphical element to cause smart contract application to create a milestone.

If smart contract application does not detect a milestone trigger, the method can proceed to step 320 wherein status of contract completion is checked. Alternatively, if smart contract application detects a milestone trigger at 316, method 300 can proceed to step 318 wherein a milestone is created and stored. In some embodiments, storage of milestone can include saving the milestone using distributed ledger technology such as blockchain technology. Milestones may also be stored locally on the device, on a private server, or by utilizing ‘cloud’ storage.

Once milestone creation and storage are complete, the method can proceed to step 320 wherein the status of the contract is verified. If the contract is not complete, the method can return to step 306 for further commands, functions, review, etc. If the contract is complete, the method can proceed to step 322 where it returns to previous processing, including repeating method 300.

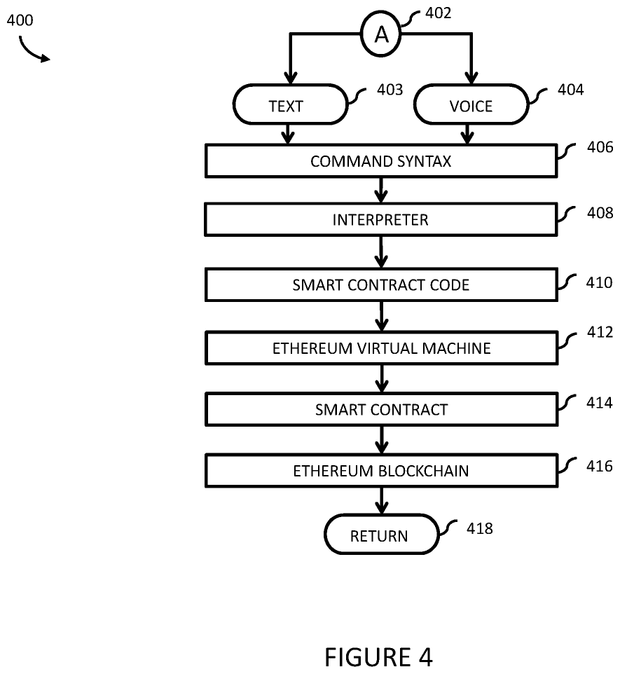

FIG. 4 illustrates an exemplary method 400 in accordance with the present technology. Method 400 begins at step 402 which can correspond to a user entering commands, such as in step 306 of method 300. Commands can be entered either in text form at step 403 or using voice to text functionality at step 404.

As described above, the syntax for commands can include a command indicator such as a ‘#’ symbol or the word “hashtag” if the user is utilizing the voice command functionality. Smart contract application can be configured to recognize the command indicator in order to parse the string of data and extract each of the commands.

Smart contract application can identify one or more commands that are associated with a particular milestone and determine that the milestone is in condition to be stored or saved to the blockchain. In this instance, smart contract application can send one or more commands to a command interpreter at step 408. As described above, the command interpreter can be configured to parse, convert, or compile the commands to generate smart contract code 410.

In some embodiments, smart contract code 410 can correspond to Solidity code. Alternatively, smart contract code can correspond to Serpent, LLL, Mutan, or Viper. Those skilled in the art will recognize that the present technology is not limited in scope to a particular programming language.

Smart contract code can be sent to a compiler to generate Ethereum Virtual Machine 412 bytecode. This bytecode can correspond to executable code for a smart contract 414 and can be deployed on the Ethereum blockchain for storage/execution/retrieval. At step 418, the method can return to previous processing, including repeating method 400.

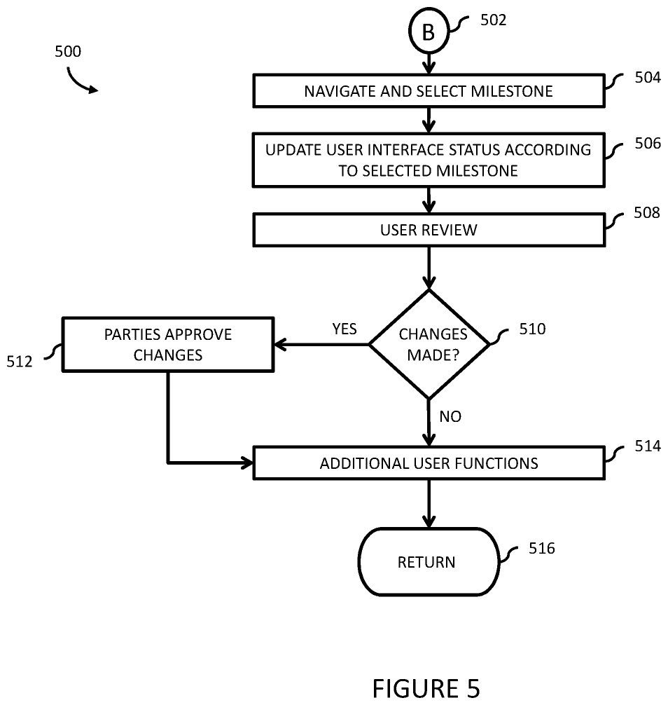

FIG. 5 illustrates an exemplary method 500 in accordance with the present technology. Method 500 begins at step 502 which can correspond to a user navigating milestones in smart contract application, such as in step 314 of method 300.

At step 504, a user may navigate milestones and select a milestone for review. In some embodiments, navigation and selection of milestones can be done by utilizing graphical user elements such as milestone navigation buttons 212. Alternatively, a user may search for a milestone by utilizing the #SEARCH command.

Once a user has selected a milestone, smart contract application can update the user interface to provide updated status that corresponds to the selected milestone at step 506. For example, smart contract application can update payment status, account balance, date(s) associated with milestone items/conditions, completed actions, pending actions, associated documents (e.g. mail, chats, photos, etc.), approval/rejection status, etc. All items can be presented to the user in the context of the selected milestone.

Once smart contract application has updated status according to the selected milestone, user can review all items at step 508. Review can include approving, rejecting, or editing one or more items that are pending in the contract. For example, if a user has loaded a milestone corresponding to the payment due date for contract completion, user may complete the payment and update the status to mark it complete. User may also revise the milestone status to add proof that the payment was made. In another example, if user has loaded a milestone corresponding to the delivery of goods, user may update the milestone status to indicate that goods have been shipped on a particular date and utilizing a particular carrier. User may also revise the milestone to include proof of shipment such as a tracking number.

If changes are made to a milestone at step 510, the method can proceed to step 512 wherein parties can approve the changes. Smart contract application can prompt or alert users to items that need approval in a particular milestone. As a continuation of the example above regarding shipment of goods, smart contract application can send an alert to the receiving party advising that the goods have been shipped. The receiving party can review, approve or acknowledge the update to the milestone. In addition, if payment is conditioned on shipment, the receiving party can further update the milestone to submit payment to the shipping party. Smart contract application can seamlessly store milestones to the blockchain as they are created, updated, approved, etc.

After the parties approve or otherwise address all pending items in a milestone, the method can proceed to step 514 wherein a user may access additional functions within smart contract application. At step 516, the method can return to previous processing, including repeating method 500.

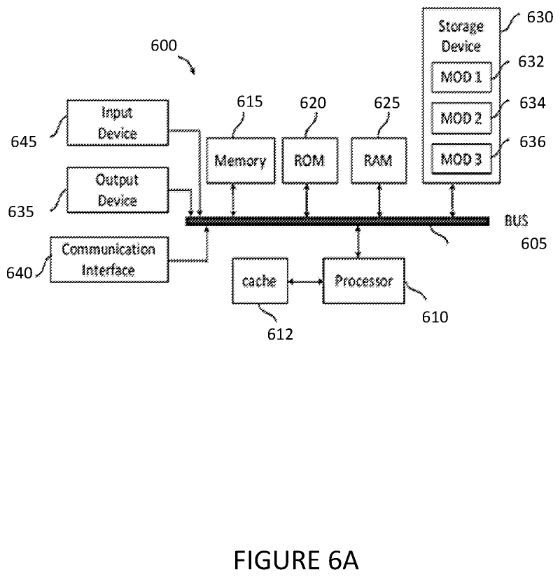

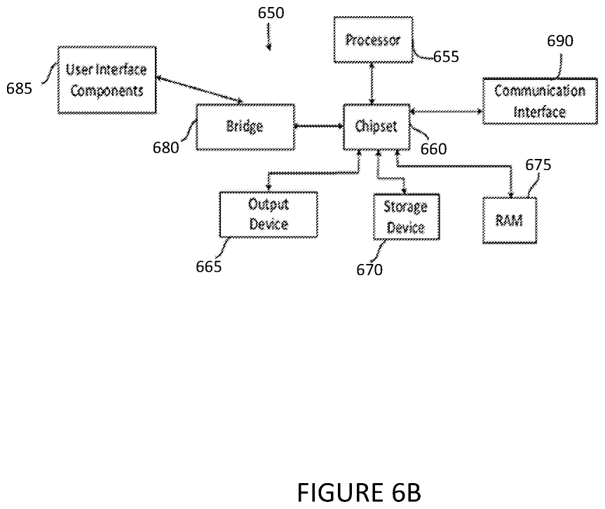

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache 612 can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output device 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, digital tablets, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Claim language reciting “at least one of” a set indicates that one member of the set or multiple members of the set satisfy the claim. Tangible computer-readable storage media, computer-readable storage devices, or computer-readable memory devices, expressly exclude media such as transitory waves, energy, carrier signals, electromagnetic waves, and signals per se.

1. A method for creating a smart contract, comprising:
receiving, at a first device, one or more commands including at least one parameter for the smart contract;
generating, based on the one or more commands, at least one entry in an agreement structure;
receiving, at the first device, a first input approving the at least one entry in the agreement structure;
sending, to a second device, the at least one entry in the agreement structure;
receiving, from the second device, a second input approving the at least one entry in the agreement structure;
generating, at the first device, one or more agreement milestones corresponding to the at least one entry in the agreement structure; and
sending, to a storage device, the one or more agreement milestones.

2. The method of claim 1, further comprising:
converting the one or more agreement milestones into a contract oriented programming language, and wherein the storage device corresponds to a distributed ledger technology.

3. The method of claim 1, wherein the one or more commands include a conditional offer for the smart contract.

4. The method of claim 3, wherein the second input corresponds to an acceptance of the conditional offer for the smart contract.

5. The method of claim 1, wherein the one or more agreement milestones include a time milestone comprising a deadline for completion of the smart contract.

6. The method of claim 1, wherein the one or more agreement milestones include an event milestone comprising an asynchronous occurrence relating to the smart contract.

7. A method for revising a smart contract, comprising:
retrieving, by a smart contract application executing on a first device, a plurality of milestones corresponding to the smart contract and stored on a blockchain;
receiving, at the first device, a request selecting a first milestone from the plurality of milestones;
extracting, from the first milestone, one or more agreement elements;
providing an agreement structure that is based on the one or more agreement elements extracted from the first milestone;
modifying at least one element from the one or more agreement elements based upon an input received within the agreement structure; and
storing, on the blockchain, the first milestone with the modification to the at least one element.

8. The method of claim 7, further comprising:
sending, to a second device, a request to approve the modification to the at least one element;
receiving, at the first device, an approval of the modification to the at least one element; and
storing, on the blockchain, a new milestone corresponding to the smart contract that includes the approval of the at least one element.

9. The method of claim 7, further comprising:
identifying, by the smart contract application, a second device associated with a second party to the smart contract; and
sending the modification to the at least one element to the second device.

10. The method of claim 7, wherein the at least one element comprises a completion date for the smart contract.

11. The method of claim 7, wherein the at least one element comprises a monetary amount associated with the smart contract.

12. The method of claim 7, wherein the retrieving of the plurality of milestones comprises executing smart contract code.

13. A computer program product for creating smart contracts, the computer program product comprising a computer readable storage medium having program instructions embodied therewith, wherein the computer readable storage medium is not a transitory signal per se, the program instructions executable by a device to cause the device to perform a method comprising:
displaying, by the device, an instruction window configured to receive commands pertaining to a smart contract;
displaying, by the device, an agreement window comprising one or more elements pertaining to the smart contract; and
displaying, by the device, a milestone window configured to navigate a timeline of agreement milestones associated with the smart contract, wherein a selection of a first milestone from the timeline of agreement milestones causes the device to update the one or more elements in the agreement window.

14. The computer program product for creating smart contracts of claim 13, the method further comprising:
displaying, by the device, an interface for approving or rejecting each of the one or more elements pertaining to the smart contract.

15. The computer program product for creating smart contracts of claim 14, the method further comprising:
receiving, by the device, an input approving at least one element from the one or more elements pertaining to the smart contract; and
sending, to a second device associated with a second party to the smart contract, a request for approval of the at least one element.

16. The computer program product for creating smart contracts of claim 13, the method further comprising:
displaying, by the device, at least one field that includes a monetary amount associated with the smart contract.

17. The computer program product for creating smart contracts of claim 13, wherein the commands in the instruction window are preceded by a command indicator.
